(19) United States
(12) Patent Application Publication
(10) Pub. No.: US 2013/0168424 A1
(43) Pub. Date: Jul. 4, 2013

(54) APPARATUS FOR HOLDING PORTABLE DEVICES

(71) Applicant: Eagle Fan, Hsinchu (TW)

(72) Inventor: Eagle Fan, Hsinchu (TW)

(21) Appl. No.: 13/342,490

(22) Filed: Jan. 3, 2012

(51) Int. Cl. B60R 7/00

(52) U.S. Cl. 224/400

(57) ABSTRACT

A holding apparatus is provided, including a receiving base, an upper lid at least a resilient element, and a suction unit. The receiving base and the upper lid are coupled at one side. The resilient element provides the elastic force to pull the upper lid and the receiving base towards each other. The suction unit is installed at the receiving base, including a suction disc for attaching to a fixed surface. The suction disc is exposed from the bottom surface of the receiving base. In this manner, the present invention can be fastened to a surface through the suction disc to provide the clamping force on a portable electronic device between the receiving base and the upper lid so that the portable electronic device is fastened to the present invention in a tilt position.

### FIELD OF THE INVENTION

The present invention generally relates to an apparatus for holding devices, and more specifically to an apparatus for holding portable electronic device with easy operation and effective clamping.

### BACKGROUND OF THE INVENTION

A holding apparatus applicable to vehicle must provide easy operation, firm clamp and resistance to mobility to be effective. The easy operation criterion refers to the ease of placing an object into the holding apparatus or removing an object from the holding apparatus, preferably only with simple hand or finger movements. The firm clamp criterion refers to the object, once clamped, will stay firmly in clamp until released from the holding apparatus. The resistance to mobility criterion refers to that the holding apparatus must stay where it is placed inside the vehicle without shifting caused by vehicle vibration, turning or average swirling.

In addition, different criteria may be required as the held portable device differs in function. For example, if the held portable device includes a viewing screen, such as, GPS, smart phone with GPS function, and so on, the holding apparatus must allow the adjustment of the angle to provide the optimal viewing angle to the screen and avoid the direct sun on the screen. Therefore, it is imperative to devise a holding apparatus to meet the requirements of firm clamp, resistance to mobility and sun shielding.

### SUMMARY OF THE INVENTION

The primary object of the present invention is to provide a holding apparatus meeting the requirements of firm clamp, resistance to mobility and sun shielding. The holding apparatus allows a portable electronic device to be clamped firmly and fastened to a location, as well as provides shielding function from the sun so that the user can view the screen more clearly. When not in use, the present invention can be folded into a box shape with aesthetic appearance, light weight and high portability.

To achieve the aforementioned object, the present invention provides a holding apparatus, including a receiving base, an upper lid at least a resilient element, and a suction unit. The receiving base and the upper lid are coupled at one side. The resilient element provides the elastic force to pull the upper lid and the receiving base towards each other. The suction unit is installed at the receiving base, including a suction disc for attaching to a fixed surface. The suction disc is exposed from the bottom surface of the receiving base. In this manner, the present invention can be fastened to a surface through the suction disc to provide the clamping force on a portable electronic device between the receiving base and the upper lid.

Furthermore, the present invention uses the suction unit to be attached to a location to enhance the fastening. In addition, the present invention can further includes a viscous resilient body at the bottom of the suction disc so that the suction disc can also suck on non-smooth surface with tiny and shallow prints or curvature, often seen in genuine leather or artificial leather. In this manner, the present invention can also be placed on and fastened to the flat top surface above the dash board. With the sun shielding capability and firm clamp, the present invention provide more convenience for using inside a vehicle.

The present invention further includes a flip element at the upper lid. The flip element is located close to the center line of the coupling between the upper lid and the receiving base. Therefore, the flip element is used for opening the upper lid in a more stable manner.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a holding apparatus according to the invention;

FIG. 2 shows a cross-sectional view of a holding apparatus according to the invention;

FIG. 3 shows a schematic view of a partial structure of the holding apparatus according to the invention; and

FIG. 4 shows a schematic view of an actual application of the present invention.

### DETAILED DESCRIPTION OF THE PREFERRED EMBODIMENTS

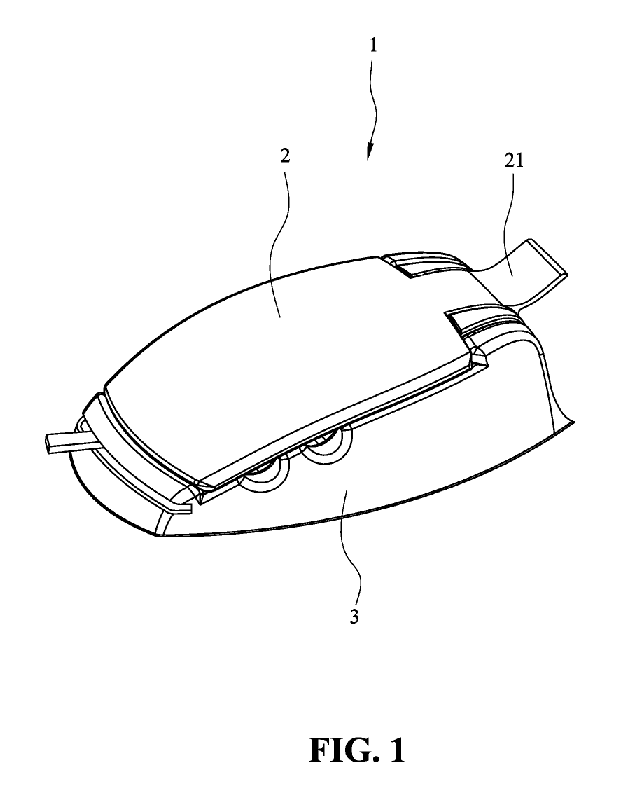

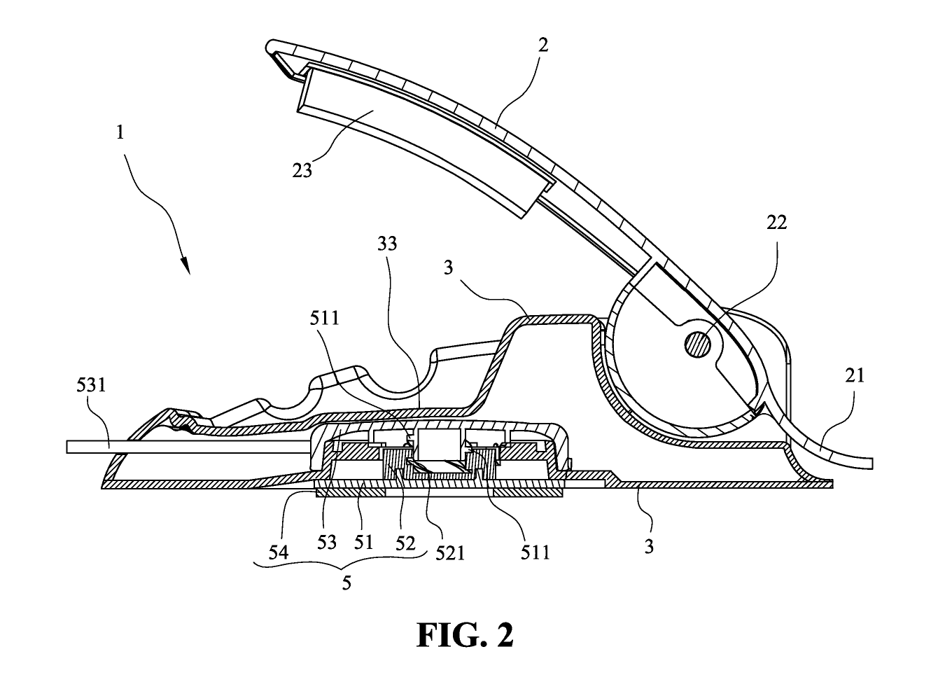

FIG. 1 and FIG. 2 show a schematic view and a cross-sectional view of the present invention, respectively. A holding apparatus 1 of the present invention includes an upper lid 2, a receiving base 3, at least a resilient element 4, and a suction unit 5. Receiving base 3 is coupled to upper lid 2 on one side. Resilient element 4 is located in the coupling structure between receiving base 3 and upper lid 2 to provide a force to pull upper lid 2 and receiving base 3 towards each other so that receiving base 3 and upper lid 2 can form a box shape when not clamping any object. Suction unit 5 is installed at receiving base 3, including a suction disc 51 able to fasten to a surface. Suction disc 51 is exposed from the bottom surface of receiving base 3. In this manner, suction disc 51 can be used to attach to a surface. A force is applied to a flip element 21 on upper lid 2 to open upper lid 2 so that a portable electronic device can be placed between upper lid 2 and receiving base 3. Resilient element 4 provides force to clamp the portable device.

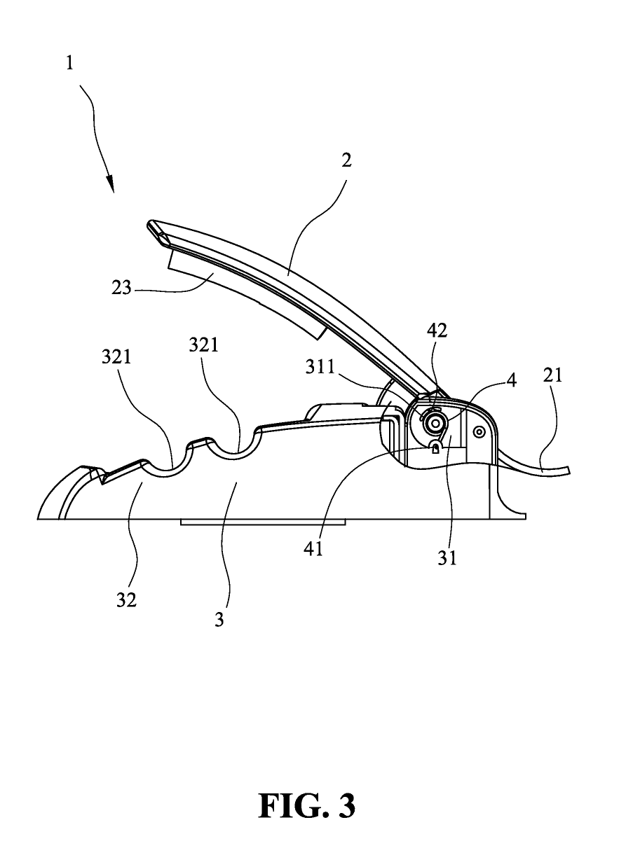

The following describes the elements of the present invention in details. The present invention uses upper lid 2 and receiving base 3 for clamping an object. As shown in FIG. 3, upper lid 2 includes at least an axial element 22, and receiving base 3 includes at least a bearing wall 31. Axial element 22 passes the axial hole of bearing wall 31. Upper lid 2 and receiving base 3 are engaged in a coupling manner for convenient opening and closing. Resilient element 4 can be a torque spring for providing force to close upper lid 2 and receiving base 3 when not holding any object. To open upper lid 2 from receiving base 3, a force must be applied to overcome the resilient force provided by resilient element 4. In the present embodiment, resilient element 4 is a torque spring sheathed on the outside of axial element 22. The torque spring has a first end 41 and a second end 42. Bearing wall 31 further includes an arc groove 311. When assembled, first end 41 is fixed to receiving base 3 and second end 42 is engaged to upper lid 2 through arc groove 311. In this manner, because of resilient element 4, upper lid 2 and receiving base 3 are closed when not external force is applied.

The shape of receiving base 3 should match the shape of upper lid 2 so as to achieve a box-like appearance when closed. The present invention uses the inner walls of receiving base 3 and upper lid 2 to clamp on the lower edge and upper edge of the object respectively. To keep the clamped object in a tilt position, the inner wall of upper lid 2 facing receiving base 3 further includes a maintaining element 23, which can be made of material with high friction. Receiving base 3 includes at least a positioning wall 32 and a contact wall 33, as shown in FIG. 2. Contact wall 33 is the top surface wall of receiving base, and position wall 32 is located on both sides of contact wall 33. Positioning walls 32 has at least an arc-shape positioning groove 321 to provide different placement locations of lower edge of object. The surface of contact wall 33 is made of anti-slip material. The present invention uses upper lid 2 and receiving base 3 to clamp on the top edge and the bottom edge of the object. With the change of contact location of the object top edge and maintaining element 23, or the change of contact location of object bottom edge and positioning wall 32 or contact wall 33, the object will be clamped in different tilt positions. When clamping an object, upper lid 2 will protrude beyond one side of the object to provide sun shielding effect.

For convenient opening and closing of upper lid 2, upper lid 2 further includes a flip element 21. Flip element 21 and a majority of the structure of upper lid 2 are located on the two opposite sides of the coupling structure so that when a force is applied to flip element 21, upper lid is easier for lift and receiving base 3 will not be prone to tilting upwards.

As shown in FIG. 2, suction unit 5 uses suction disc 51 to attach to fixed surface. The mechanism of linked movement for pulling suction disc 51 up can be realized in different ways. The present embodiment is only for illustrative purpose, rather than restrictive purpose. Suction unit 5 includes a suction disc 51, a pull element 52 and a rotational button 53. Pull element 52 is fixed to the top of suction disc 51 to pull the central region of suction disc 51 upwards. Rotational button 53 is installed at receiving base 3, and is only for rotation. Pull element 52 is also installed at receiving base 3, and is only able to perform linear movement vertically. Rotational button 53 and pull element 52 are engaged to each other in a screw manner. In other words, the outside of the pillar wall at the inside of rotational button 53 includes a screw block 531 with at least an inner screw mark. Correspondingly, the wall of the central hole inside pull element 52 includes a guiding track 521 with at least an outer screw mark. When assembled, screw block 531 will be placed inside guiding track 521. When rotational button 53 rotates in a specific direction, pull element 52 will move in the direction perpendicular to the surface of suction disc 51 so that suction disc can attach to the surface to be fixed to.

In the present embodiment, the rotation range of rotational button 53 is less than 120°. For easy operation, rotational button 53 further includes a flip rod 532, with one end engaged to rotational button 53 and the other end extending beyond through opening 33 of receiving base 3. Opening 33 has a width for allowing flip rod 531 to move within a certain range so that rotational button 53 can rotate. However, other embodiments are also possible. For example, an opening can be formed on contact wall 33 of receiving base 3 to partially expose rotational button 53 so that the user can rotate rotational button 53 from inside.

Furthermore, to widen the application of the holding apparatus of the present invention, suction disc 51 of the present invention is not necessary to attach to only completely smooth surface. For example, the genuine leather or artificial leather used on the top surface of the dash board or other material with small and shallow prints or curvatures is often seen inside a vehicle. Therefore, the bottom surface of suction disc 51 includes a viscous resilient body 54. Resilient body 54 is made of material softer than suction disc 51. The present embodiment uses PU for elastomers, which is soft and viscous on the surface. The material is also washable with water when dirty.

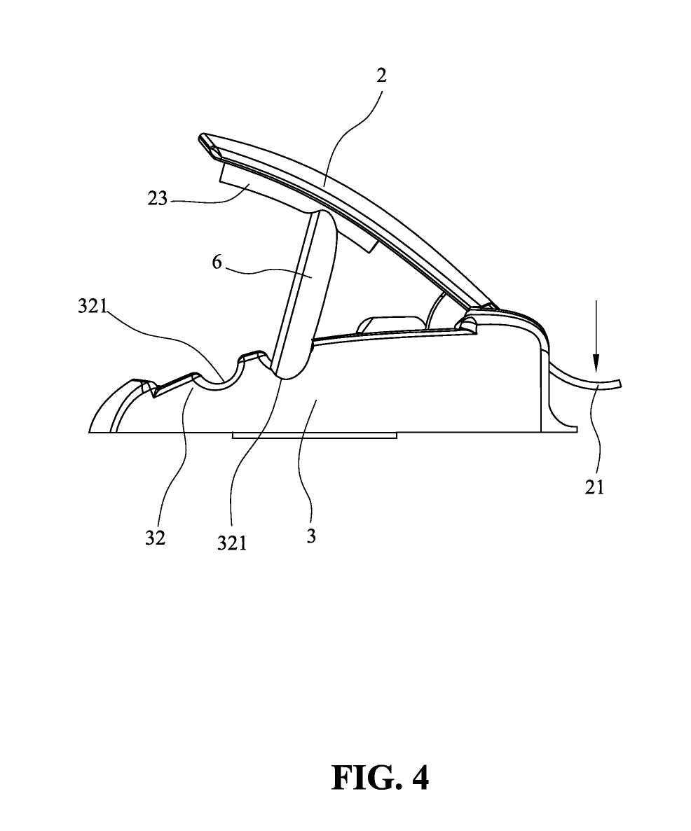

As shown in FIG. 4, to prevent holding apparatus 1 from moving during the vehicle driving, the present invention uses suction disc 51 with resilient body 54 at the bottom to attach to the top surface of the dash board. To place an object inside holding apparatus 1, a single hand can be used to apply a force on flip element 21 of upper lid 2 to open upper lid 2. Then, portable electronic device, such as, mobile phone 6, is placed between upper lid 2 and receiving base 3. Maintaining element 23 contacts the top edge of mobile phone 6, and positioning groove 321 of positioning wall 32 provides placement location for the bottom edge of mobile phone 6. Then, the force applied to flip element 21 is released and the force of resilient element 4 will cause upper lid 2 and receiving base 3 to clamp mobile phone 6 so that mobile phone will be held in a tilt position. Upper lid 2 protruding beyond the front edge of mobile phone provides the sun shielding effect to prevent the sun shine directly on mobile phone 6 for optimal viewing result.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for holding portable device, applicable to a vehicle, comprising:
a receiving base, an upper lid, at least a resilient element and a suction unit;
wherein said receiving base and said upper lid coupled at one side, said resilient element providing force to pull said upper lid and said receiving base towards each other so that said upper lid and said receiving base forming a box-shape when not holding said portable device, said suction unit installed at said receiving base, further comprising a suction disc able to suck and attach to a surface for fastening, said suction disc being exposed from a bottom surface of said receiving base.

2. The apparatus as claimed in claim 1, wherein said resilient element is a torque spring with two ends connected to said receiving base and said upper lid, respectively.

3. The apparatus as claimed in claim 1, wherein an inner wall of said upper lid facing said receiving base comprises a maintaining element made of material with high friction, said receiving base comprises at least a positioning wall and a contact wall, when clamping a top edge of an object contacts said maintaining element and a bottom edge of said object contacts said positioning wall or said contact wall to make said object clamped in a tilt position.

4. The apparatus as claimed in claim 1, wherein said suction unit further comprises a suction disc, a pull element and a rotational button, said pull element is fixed to top of said suction disc, said rotational button is installed at said receiving base and is only for rotation, said pull element is also installed at said receiving base and is only able to perform linear movement vertically, said rotational button and said pull element are engaged to each other in a screw manner, when said rotational button rotates in a specific direction, said pull element will move in the direction perpendicular to surface of said suction disc so that said suction disc can attach to a surface to be fixed to.

5. The apparatus as claimed in claim 4, wherein said rotational button further comprises a flip rod, with one end engaged to said rotational button and the other end extending beyond through an opening of said receiving base, said opening has a width for allowing said flip rod to move within a certain range so that said rotational button can rotate.

6. The apparatus as claimed in claim 1, wherein a bottom surface of said suction disc further comprises a viscous resilient body, made of a material softer than said suction disc.

7. The apparatus as claimed in claim 6, wherein said resilient body is made of a PU for elastomers.
